(19) United States
(12) Patent Application Publication
(10) Pub. No.: US 2011/0221799 A1
(43) Pub. Date: Sep. 15, 2011

(54) PRINTING SYSTEM, METHOD FOR PROCESSING IMAGE DATA, AND NON-TRANSITORY COMPUTER-READABLE RECORDING MEDIUM HAVING STORED THEREON PROGRAM FOR ALLOWING COMPUTER TO PERFORM IMAGE PROCESSING METHOD

(75) Inventor: Natsumi IKEDA, Tomi-city (JP)

(73) Assignee: MIMAKI ENGINEERING CO., Ltd., Tomi-city (JP)

(21) Appl. No.: 13/074,028

(22) Filed: Mar. 29, 2011

Related U.S. Application Data
(63) Continuation of application No. PCT/JP2009/050381, filed on Jan. 14, 2009.

(51) Int. Cl. H04N 1/034

(52) U.S. Cl. 347/3

(57) ABSTRACT

A printing system includes inkjet printing apparatuses to print a same image based on output image data having been adjusted depending on color reproduction characteristic with respect to each of the inkjet printing apparatuses. An image processing apparatus includes an output image generating device configured to convert printing data to the output image data representing image with a color depending on color reproduction characteristic of ink. The output image generating device includes a rasterizer and an apparatus common color convertor configured to execute common color conversion for the inkjet printing apparatuses using one ICC profile common to the inkjet printing apparatuses. An adjuster is configured to reduce variation of the color reproduction characteristic with respect to each of the inkjet printing apparatuses using calibration information prepared for each of the inkjet printing apparatuses depending on the color reproduction characteristic with respect to each of the inkjet printing apparatuses.

### CROSS-REFERENCE TO RELATED APPLICATIONS

The present application is a continuation application of International Application No. PCT/JP2009/050381, filed Jan. 14, 2009. The contents of this application are incorporated herein by reference in their entirety.

### BACKGROUND OF THE INVENTION

1. Field of the Invention

The present invention relates to a printing system, a method for processing image data, and a non-transitory computer-readable recording medium having stored thereon a program for allowing a computer to perform an image processing method.

2. Discussion of the Background

Conventionally, a method where distributed printing is performed by using a plurality of printing apparatuses has been known. For example, a plurality of inkjet printers having the same specification is used as the printing apparatus.

When a plurality of printing apparatuses is used, color difference may occur in each of the printing apparatuses to cause variation of color reproduction characteristic. Therefore, in this case, for example, variation of color reproduction characteristic of each printing apparatus is required to restrain by an appropriate method.

In order to restrain the variation of color reproduction characteristic of each printing apparatus, various methods have been conventionally proposed for restraining an individual difference of printing result of each printing apparatus (see, for example, Japanese Patent Laid-Open No. 2004-46339, Japanese Patent Laid-Open No. 2004-234391 and Japanese Patent Laid-Open No. 2007-137013). For example, in the structure disclosed in Japanese Patent Laid-Open No. 2004-46339, a plurality of color conversion informations corresponding to respective inkjet printers are respectively created and color conversion tables corresponding to the respective color conversion informations are transmitted to a plurality of printers which are specified depending on the operating conditions.

### SUMMARY OF THE INVENTION

According to one aspect of the present invention, a printing system includes a plurality of inkjet printing apparatuses and an image processing apparatus. The plurality of inkjet printing apparatuses are to print a same image based on output image data having been adjusted depending on color reproduction characteristic with respect to each of the plurality of inkjet printing apparatuses. The image processing apparatus is configured to generate output image data representing image to be printed by each of the plurality of inkjet printing apparatuses. The image processing apparatus includes a printing data acquisition device, an output image generating device, and a data output processing device. The printing data acquisition device is configured to acquire printing data which represent the image with a color of a color system that does not depend on color reproduction characteristic of ink used in the plurality of inkjet printing apparatuses. The output image generating device is configured to convert the printing data to the output image data which represent the image with a color depending on the color reproduction characteristic of ink used in the plurality of inkjet printing apparatus. The output image generating device includes a rasterizer, an apparatus common color convertor, and an adjuster. The rasterizer is configured to rasterize the image represented by the printing data according to resolution of the plurality of inkjet printing apparatus. The apparatus common color convertor is configured to execute common color conversion for the plurality of inkjet printing apparatuses using one ICC profile common to the plurality of inkjet printing apparatuses. The adjuster is configured to reduce variation of the color reproduction characteristic with respect to each of the plurality of inkjet printing apparatuses using calibration information which is prepared for each of the plurality of inkjet printing apparatuses depending on the color reproduction characteristic with respect to each of the plurality of inkjet printing apparatuses to generate the output image data having been adjusted depending on the color reproduction characteristic with respect to each of the plurality of inkjet printing apparatuses. The data output processing device is configured to output the output image data having been generated to the plurality of inkjet printing apparatuses.

According to another aspect of the present invention, a method for processing image data includes acquiring a printing data which represent the image with a color of a color system that does not depend on color reproduction characteristic of ink used in a plurality of inkjet printing apparatus to print of a same image based on output image data having been adjusted depending on the color reproduction characteristic with respect to each of the plurality of inkjet printing apparatuses. The printing data is converted to the output image data which represent the image with a color depending on the color reproduction characteristic of ink and based on the plurality of inkjet printing apparatuses are to print. The image represented by the printing data is rasterized according to resolution of each of the plurality of inkjet printing apparatuses. Common color conversion for the plurality of inkjet printing apparatuses is executed using one ICC profile common to the plurality of inkjet printing apparatuses. Variation of color reproduction characteristic with respect to each of the plurality of inkjet printing apparatuses is reduced using calibration information which is prepared for each of the plurality of inkjet printing apparatuses depending on the color reproduction characteristic with respect to each of the plurality of inkjet printing apparatuses to generate the output image data having been adjusted depending on the color reproduction characteristic with respect to each of the plurality of inkjet printing apparatuses. The output image data having been generated is outputted to the plurality of inkjet printing apparatuses.

According to further aspect of the present invention, a non-transitory computer-readable recording medium having program code stored thereon which, when executed by a computer, causes the computer to perform an image processing method for performing a plurality of application programs. The image processing method includes acquiring printing data which represent image with a color of a color system that does not depend on color reproduction characteristic of ink used in a plurality of inkjet printing apparatus to print of a same image based on output image data having been adjusted depending on color reproduction characteristic with respect to each of the plurality of inkjet printing apparatuses. The printing data is converted to the output image data which represent the image with a color depending on the color reproduction characteristic of ink and based on the plurality of inkjet printing apparatuses are to print. The image represented by the printing data is rasterized according to resolution of each of the plurality of inkjet printing apparatuses. Common color conversion for the plurality of inkjet printing apparatuses is executed using one ICC profile common to the plurality of inkjet printing apparatuses. Variation of the color reproduction characteristic with respect to each of the plurality of inkjet printing apparatuses is reduced using calibration information which is prepared for each of the plurality of inkjet printing apparatuses depending on the color reproduction characteristic with respect to each of the plurality of inkjet printing apparatuses to generate the output image data having been adjusted depending on the color reproduction characteristic with respect to each of the plurality of inkjet printing apparatuses. The output image data having been generated is outputted to the plurality of inkjet printing apparatuses.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a view showing an example of a structure of a printing system which uses a program in accordance with an embodiment of the present invention;

FIG. 2 is a flow chart showing an example of an operation of an image formation processing in PC;

FIG. 3 is a flow chart showing an example of an operation for creating calibration information; and

FIG. 4 is a view showing an example of a structure of an ICC profile and a plurality of calibration informations.

### DESCRIPTION OF THE EMBODIMENTS

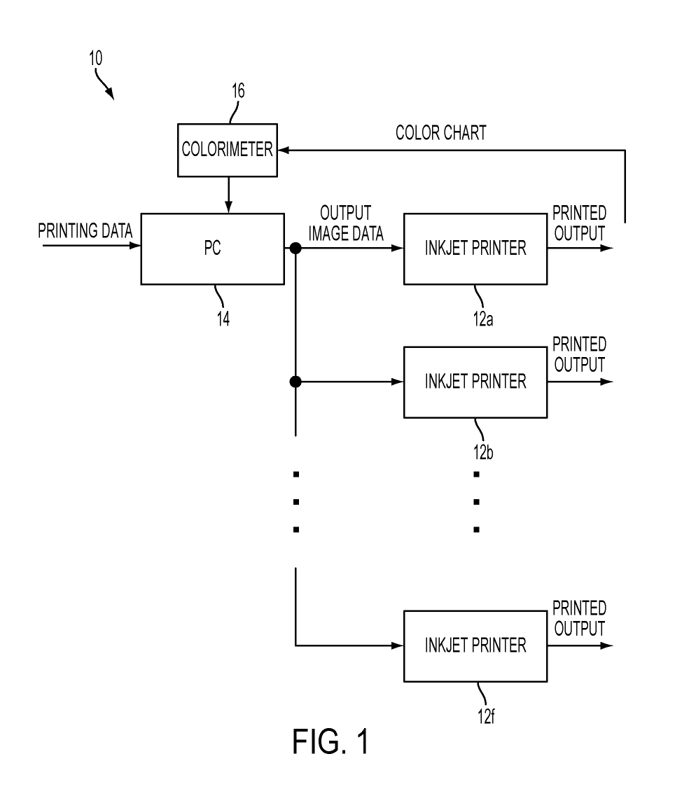

The embodiments of the present invention will be described below with reference to the accompanying drawings, wherein like reference numerals designate corresponding or identical elements throughout the various drawings. FIG. 1 is a view showing a structure of a printing system 10 which uses a program in accordance with an embodiment of the present invention. The printing system 10 is a printing system for performing distributed printing by using a plurality of printing apparatuses and is provided with a plurality of inkjet printers 12a through 12f, a colorimeter 16 and a PC 14.

Each of a plurality of the inkjet printers 12a through 12f is a printing apparatus for distributed printing, which is provided with inkjet heads from which inks of respective colors of CMYK inks are ejected. Further, in this embodiment, the inkjet printers 12a through 12f perform printing in a multi-pass system through scanning operations where inkjet heads are reciprocated in a predetermined scanning direction. When distributed printing is to be executed, the inkjet printers 12a through 12f receive output image data adjusted depending on color reproduction characteristics of the respective inkjet printers 12a through 12f from the PC 14 to perform printing of the same image on the basis of the received output image data. The output image data are output data of image formation processing executed in the PC 14.

Further, for example, in a case that creation of calibration information which is used for adjustment of color reproducibility is executed or the like, the inkjet printers 12a through 12f respectively print preset color charts according to instructions of the PC 14. The calibration information is, for example, information which is used for adjustment of color conversion in an image formation processing.

A plurality of the inkjet printers 12a through 12f is, for example, an inkjet printer having the same specification and printing is performed by using the same ink. The inks are those for color printing such as inks for respective colors of CMYK inks.

The colorimeter 16 is, for example, a colorimeter which is the same as or similar to a well-known colorimeter. In this embodiment, the colorimeter 16 is provided on an outer side of the inkjet printers 12a through 12f and performs color measurement of color charts which are respectively printed by the inkjet printers 12a through 12f.

The PC 14 is a host computer which is provided on an outside of the inkjet printers 12a through 12f and operates as an image formation device in the printing system 10 according to a program which has been previously installed. In accordance with an embodiment, the image forming device of the printing system 10 may be structured of a computer, a database provided on an outside of the computer, and the like. Further, the image forming device may be structured of a plurality of computers.

In this embodiment, the PC 14 stores ICC profiles corresponding to device characteristics of the inkjet printers 12a through 12f and executes an image formation processing on the basis of the ICC profile according to a program. In this embodiment, the image formation processing is an “RIP” processing. Further, in the image formation processing, the PC 14 forms output image data which are transferred to the inkjet printers 12a through 12f. In the image formation processing, the PC 14 receives printing data such as a post script file or a PDF file from the outside to form output image data corresponding to the printing data.

The image formation processing in the PC 14 will be described further in detail below. The PC 14 may form output image data on the basis of printing data prepared by using an application program on the PC 14.

Further, in this embodiment, the PC 14 acquires color measurement results of the colorimeter 16 and creates calibration information on the basis of the color measurement results. An operation for creating the calibration information will be described in detail below.

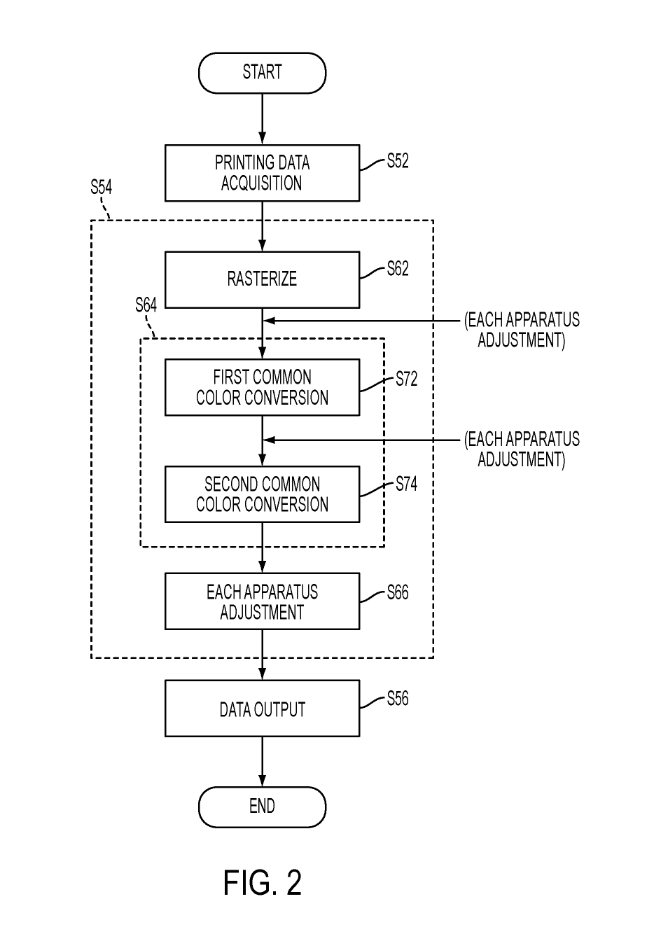

Next, an operation of the PC 14 will be described further in detail below. First, an operation of an image formation processing is described. FIG. 2 is a flow chart showing an example of an operation of the image formation processing in the PC 14. The PC 14 executes the following operation, for example, according to a program having been installed in advance.

First, the PC 14 acquires printing data, for example, from the outside computer or from an application program executed in the PC 14 (printing data acquisition processing S52). The printing data are, for example, a post script file or a PDF file and an image to be printed is shown by colors of a color system independent to the color reproduction characteristics of inks which are used in the inkjet printers 12a through 12f. In this embodiment, the color of the color system is, for example, a color of an RGB color system or the like. The device depending color may be a device depending color which is dependent on the color reproduction characteristic of a device on a side for preparing printing data.

Next, the PC 14 converts the printing data into output image data to create the output image data (output image creation processing S54). In this embodiment, the output image creation processing S54 is an RIP processing in which output image data showing image with colors of CMYK color system are created on the basis of the printing data. The colors of the CMYK color system are, for example, colors depending on color reproduction characteristics of CMYK inks which are used in the inkjet printers 12a through 12f. Further, the output image data are data, for example, including developed raster image data and commands which are capable of being interpreted by the inkjet printers 12a through 12f. The output image data may be data showing an image with a printer description language.

In the output image creation processing S54, first, the PC 14 performs rasterization of the image which is shown by the printing data according to the resolutions of the inkjet printers 12a through 12f (rasterize processing S62). Next, color conversion is executed for a plurality of the inkjet printers 12a through 12f by using a common ICC profile (apparatus common color conversion processing S64).

Further, in the apparatus common color conversion processing S64 in this embodiment, the PC 14 executes two times of color conversion (first common color conversion processing S72 and second common color conversion processing S74). In the first common color conversion processing S72, the PC 14 executes color conversion with the use of the first ICC profile common to a plurality of the inkjet printers 12a through 12f and the device depending color which is used in the printing data is converted into a device independent color. The first ICC profile is, for example, an ICC profile in which a color expressed by the RGB color system is corresponded to a color expressed by the Lab color system.

Further, after the first common color conversion processing S72, in the second common color conversion processing S74, the PC 14 executes color conversion with the use of the second ICC profile common to a plurality of the inkjet printers 12a through 12f and the converted device independent color by the first common color conversion processing is converted into a device depending color which is dependent upon the color reproduction characteristic of ink. The second ICC profile is, for example, an ICC profile in which a color expressed by the Lab color system is corresponded to a color expressed by the CMYK color system.

In this manner, the PC 14 executes color matching common to a plurality of the inkjet printers 12a through 12f. In accordance with an embodiment of the present invention, the PC 14 may further execute another processing common to a plurality of the inkjet printers 12a through 12f before or after the rasterize processing S62 or the apparatus common color conversion processing S64. For example, the PC 14 may further execute a rendering processing and the like.

Next, the PC 14 executes an individual adjustment of color conversion for each of the inkjet printers 12a through 12f (each apparatus adjustment processing S66). In the each apparatus adjustment processing S66, the PC 14 executes adjustment for reducing variation of the color reproduction characteristic in each of a plurality of the inkjet printers 12a through 12f by using calibration information prepared for each of the inkjet printers 12a through 12f. In this manner, the PC 14 creates output image data which are adjusted depending on the color reproduction characteristic of each of the inkjet printers 12a through 12f as output image data which are sent to each of the inkjet printers 12a through 12f.

In this embodiment, the calibration information is, for example, information which makes a color of the CMYK color system correspond to a color of the CMYK color system and the color of the CMYK color system in the ICC profile used in the second common color conversion processing S74 is corresponded to a color which has been executed with correction for each of the inkjet printers 12a through 12f. Further, the calibration information is, for example, prepared for each of the inkjet printers 12a through 12f depending on the color reproduction characteristics of each of the inkjet printers 12a through 12f.

As described above, the PC 14 executes the RIP processing based on the printing data to create output image data. Next, the PC 14 outputs the created output image data to the inkjet printer 12 (data output processing S56). In this manner, the PC 14 makes the inkjet printer 12 execute a printing operation.

According to this embodiment, for example, color difference occurred due to individual difference in a plurality of the inkjet printers 12a through 12f can be absorbed appropriately. Therefore, for example, variation of the color reproduction characteristic of each of the inkjet printers 12a through 12f can be reduced appropriately. In addition, since variation of color reproduction characteristic is reduced, for example, distributed printing can be performed appropriately.

Further, since the processing using the ICC profile common to a plurality of the inkjet printers 12a through 12f is separated from the processing using the calibration information prepared for each of the inkjet printers 12a through 12f, for example, the processing except the each apparatus adjustment processing can be appropriately made common for a plurality of the inkjet printers 12a through 12f. Therefore, according to this embodiment, for example, the image formation processing can be appropriately executed at a high speed.

In addition, in this embodiment, for example, different from a case that an ICC profile is separately prepared for each of the inkjet printers 12a through 12f, only the common ICC profile is prepared for a plurality of the inkjet printers 12a through 12f. Therefore, according to this embodiment, for example, work man-hours required to prepare the ICC profile can be reduced remarkably.

In accordance with an embodiment of the present invention, the PC 14 may execute the each apparatus adjustment processing at a timing different from the above-mentioned embodiment. For example, the PC 14 may execute the each apparatus adjustment processing before the first common color conversion processing S72. In this case, in the each apparatus adjustment processing, color correction is executed on the data created by the rasterize processing S62. Further, for example, information for correcting the device depending color which is used in the printing data is used as the calibration information. The calibration information makes, for example, the device depending color, which is used in the data before the first common color conversion processing is executed, correspond to the color in which correction for each of the inkjet printers 12a through 12f has been executed.

Further, the PC 14 may execute the each apparatus adjustment processing after the first common color conversion processing S72 and before the second common color conversion processing S74. In this case, as the calibration information, for example, information is used which corrects the device independent color after converted by the first common color conversion processing. The calibration information makes, for example, the device independent color after converted by the first common color conversion processing S72 correspond to the color in which correction for each of the inkjet printers 12a through 12f has been executed.

Further, the PC 14 may, for example, execute the each apparatus adjustment processing at a plurality of timings. For example, the each apparatus adjustment processing may be executed at two or more timings among a timing before the first common color conversion processing S72, a timing after the first common color conversion processing S72, and a timing after the second common color conversion processing S74. In this case, the PC 14 executes the respective each apparatus adjustment processings by using the calibration information corresponding to the respective timings.

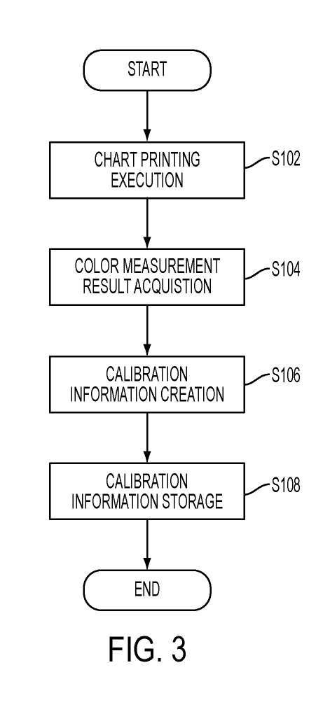

Next, an operation for creating the calibration information will be described blow. FIG. 3 is a flow chart showing an operation for creating the calibration information. The PC 14 executes the following operation, for example, according to a program having been installed in advance.

First, the PC 14 makes a plurality of the inkjet printers 12a through 12f execute printing of color charts (color chart printing execution processing S102). In this processing, the PC 14 sends, for example, common output image data representing a color chart to each of a plurality of the inkjet printers 12a through 12f to perform printing the same color chart. The color chart is, for example, a color chart including primary colors and patches of high order colors.

Next, after the colorimeter 16 has executed color measurement for the printed color chart which had been printed by each of the inkjet printers 12a through 12f, the PC 14 acquires color measurement results of the colorimeter 16 (color measurement result acquisition processing S104). In this manner, the PC 14 acquires a color measurement result for the printing result of each of a plurality of the inkjet printers 12a through 12f.

Next, the PC 14 creates a plurality of calibration informations respectively corresponding to a plurality of the inkjet printers 12a through 12f on the basis of the acquired color measurement results (calibration information creation processing S106). In this processing, the PC 14 calculates, for example, a color reproduction characteristic of each of the inkjet printers 12a through 12f on the basis of the color measurement results. Next, calibration information for reducing variation of the color reproduction characteristic is created on the basis of the calculated color reproduction characteristic. The variation of the color reproduction characteristic is, for example, the variation of the color reproduction characteristic which is occurred when color conversion is executed by using only the common ICC profile.

After the calibration information creation processing S106, the PC 14 stores a plurality of calibration informations having been created, for example, to a storage device such as an HDD of the PC 14 (calibration information storage processing S108). In this processing, the PC 14 stores a plurality of the calibration informations so as to correspond to one ICC profile.

According to this embodiment, for example, the calibration information corresponding to the color reproduction characteristic of each of the inkjet printers 12a through 12f can be created appropriately. Further, in this manner, for example, the variation of the color reproduction characteristic of each of the inkjet printers 12a through 12f can be reduced appropriately.

Further, the above-mentioned calibration information can be, for example, easily and appropriately prepared with reduced man-hours in comparison with an ICC profile. Therefore, in addition, according to this embodiment, the variation of the color reproduction characteristic of each of the inkjet printers 12a through 12f can be reduced appropriately without requiring a lot of man-hours for preparation of the data required for color conversion.

Further, since the calibration information is easily prepared, adjustment and re-preparation of the calibration information can be appropriately executed as needed. For example, different from a case that adjustment and re-preparation of an ICC profile itself are executed, a user for the inkjet printers 12a through 12f is capable of preparing the calibration information for oneself. Further, for example, the calibration information can be newly prepared before starting of daily working. Therefore, according to this structure, for example, the variation of the color reproduction characteristic of each of the inkjet printers 12a through 12f can be further flexibly executed.

In the calibration information creation processing S106, the PC 14 creates, for example, the calibration information by comparing the color chart printed by each of the inkjet printers 12a through 12f with a reference color chart having been prepared previously. The reference color chart is, for example, a color chart which has been printed by one of the inkjet printers 12a through 12f. As the color chart, for example, a color chart printed by one of the inkjet printers 12a through 12f prior to delivery from a factory, a color chart printed by one of the inkjet printers 12a through 12f at a specified date or the like may be used.

Further, in the calibration information creation processing S106, for example, with the color reproduction characteristic of one of the inkjet printers 12a through 12f as a reference, the PC 14 makes match the color reproduction characteristic of the other of the inkjet printers 12a through 12f to the reference. As the reference of the inkjet printers 12a through 12f, for example, one of the inkjet printers 12a through 12f whose performance of the color reproduction characteristic is the lowest may be used. According to this structure, the color reproduction characteristics of the other of the inkjet printers 12a through 12f can be matched with the reference appropriately.

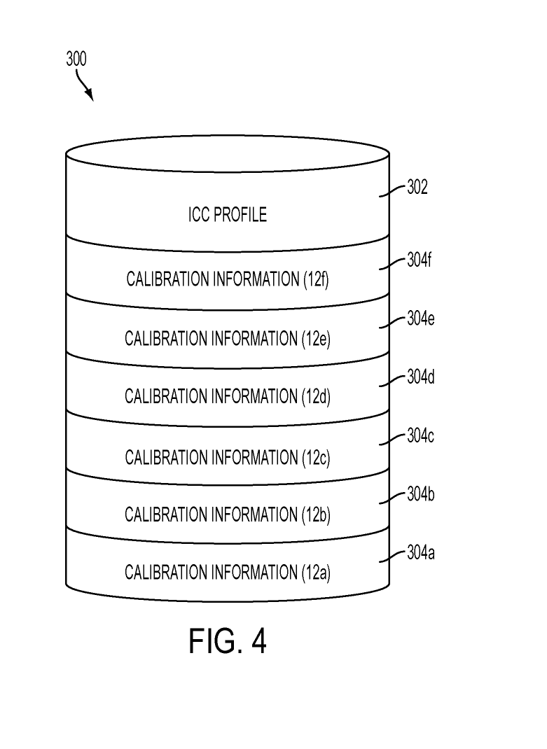

FIG. 4 is a view showing a structure of an ICC profile 302 and a plurality of calibration informations 304a through 304f. In this embodiment, the PC 14 stores the ICC profile 302 and a plurality of the calibration informations 304a through 304f within one color conversion information file 300. In this manner, the PC 14 collectively stores the ICC profile 302 common to a plurality of the inkjet printers 12a through 12f and a plurality of the calibration informations 304a through 304f corresponding to a plurality of the inkjet printers 12a through 12f within a single file. According to this embodiment, for example, the ICC profile 302 and the calibration informations 304a through 304f are managed and utilized appropriately.

Although the embodiment of the present invention has been shown and described with reference, the technical scope of the present invention is not limited to the embodiment described above. Various changes and modifications will be apparent to those skilled in the art from the teachings herein. It is clear from the description of the following claims that embodiments to which the various changes and modifications are applied are included in the technical scope of the present invention.

The above-mentioned program is provided in a recorded state on a recording medium such as a CD-ROM and installed in a computer. The computer is, for example, a host computer which controls an operation of an inkjet printer. The computer is, for example, provided on the outside of the inkjet printer.

The output image creation processing is, for example, an RIP (Raster Image Processor) processing in which output image data are formed on the basis of printing data. The output image creation processing may further execute other processing in the RIP processing. For example, the output image creation processing may further execute a rendering processing or the like.

Further, each of a plurality of printing apparatuses is, for example, an inkjet printer which is used in a printing system performing distributed printing. It is preferable that a plurality of the printing apparatuses is, for example, an inkjet printer having the same specification. Further, a plurality of printing apparatuses performs printing, for example, by using the same ink. The ink is, for example, ink for color printing such as inks of respective colors in CMYK inks. The CMYK inks are, for example, inks of respective colors of “C” (cyan), “M” (Magenta), “Y” (yellow) and “K” (black).

In this case, when there is variation of color reproduction characteristic in each of the printing apparatuses, a finish state of a printed matter may be different in each of the printing apparatuses. Further, as a result, it is difficult to perform distributed printing appropriately. On the other hand, according to the above-mentioned structure, color difference due to machine difference and the like in a plurality of the printing apparatuses can be absorbed and variation of color reproduction characteristic can be reduced appropriately. Further, as a result, for example, distributed printing can be performed appropriately.

Further, in the structure described above, since a processing using one ICC profile common to a plurality of the printing apparatuses is separated from a processing using calibration information prepared for each of the printing apparatuses, a processing except an each apparatus adjustment processing, for example, a rasterize processing and an apparatus common color conversion processing can be appropriately made common for a plurality of the printing apparatuses. Therefore, according to this structure, the image formation processing can be appropriately executed at a high speed.

Further, in the structure described above, for example, different from a case that an ICC profile is individually prepared for each of the printing apparatuses, only one common ICC profile may be prepared for a plurality of the printing apparatuses. Therefore, according to this structure, for example, work man-hours required to prepare the ICC profile can be reduced remarkably.

Preparation of an ICC profile may require a working time, for example, more than one day through one week or more. Therefore, in order to individually prepare an ICC profile for each printing apparatus, work man-hours are increased largely and thus working efficiency is remarkably reduced and cost is increased.

In accordance with an embodiment of the present invention, an each apparatus adjustment processing replaces, for example, color of data before or after or the like of conversion by the apparatus common color conversion processing with color having a value after correction by the calibration information. According to this structure, correction corresponding to color reproduction characteristic of each of the printing apparatuses can be executed appropriately.

For example, information may be used as the calibration information which corrects one of values of device depending color and device independent color in the ICC profile. In this case, the calibration information makes, for example, a value of the device depending color or the device independent color in the ICC profile correspond to a value corrected depending on color reproduction characteristic of the corresponding printing apparatus. For example, the calibration information makes a value of the device depending color in the ICC profile correspond to a value of the device depending color after correction. The calibration information may make a value of the device independent color in the ICC profile correspond to a value of the device independent color after correction.

Further, when the each apparatus adjustment processing is a processing which is to be executed before the apparatus common color conversion processing, for example, the each apparatus adjustment processing executes adjustment for reducing variation of color reproduction characteristic for data created in a rasterize processing which is executed before the apparatus common color conversion processing. In this case, for example, the calibration information makes a value of the device depending color used in the data created in the rasterize processing correspond to a value after correction.

The calibration information described above can be, for example, easily and appropriately prepared with reduced man-hours in comparison with an ICC profile. For example, the calibration information described above can be prepared for a time of several minutes to about several tens of minutes. Therefore, according to this structure, man-hours required to prepare data necessary for color conversion can be reduced appropriately. Further, according to this structure, variation of color reproduction characteristic of each of the printing apparatuses can be reduced further appropriately.

In addition, since the calibration information is easily prepared, adjustment and re-preparation of the calibration information can be appropriately executed as needed. For example, different from a case that adjustment and re-preparation of an ICC profile itself are executed, a user for the printing apparatus is capable of preparing the calibration information or the like for oneself. Further, for example, the calibration information can be newly prepared before starting of daily working or the like. Therefore, according to this structure, for example, the variation of the color reproduction characteristic of each of the printing apparatuses can be further flexibly reduced.

According to the embodiment of the present invention, for example, the calibration information corresponding to color reproduction characteristic of each of the printing apparatuses can be created appropriately. Therefore, for example, variation of color reproduction characteristic of each of the printing apparatuses can be reduced appropriately.

According to the embodiment of the present invention, for example, the each apparatus adjustment processing can be executed appropriately and efficiently. Further, according to this structure, variation of color reproduction characteristic of each of the printing apparatuses can be reduced further appropriately.

According to the embodiment of the present invention, for example, the each apparatus adjustment processing can be executed appropriately and efficiently. Further, according to this structure, variation of color reproduction characteristic of each of the printing apparatuses can be reduced further appropriately.

According to the embodiment of the present invention, for example, the each apparatus adjustment processing can be executed appropriately and efficiently. Further, according to this structure, variation of color reproduction characteristic of each of the printing apparatuses can be reduced further appropriately.

In the structures 3 through 5 described above, the device independent color in the first and the second ICC profiles is, for example, a color expressed by the “Lab” color system. As the device independent color, a color expressed by the “XYZ” color system may be used. Further, the device depending color in the second ICC profile is, for example, a color expressed by the “CMYK” color system.

Further, in the output image creation processing, the each apparatus adjustment processing may be executed plural times. For example, in the output image creation processing, the each apparatus adjustment processing may be executed twice or three times by combining two or three of the above-mentioned structures 3 through 5.

The image forming device is, for example, a computer which is provided on the outside of the inkjet printer. The computer operates as an image forming device, for example, according to a predetermined program. In this case, for example, a CPU of the computer operates as respective sections of the image forming device according to the program. Further, the image forming device may be structured of a plurality of computers.

According to the embodiment of the present invention, for example, variation of color reproduction characteristic of each of a plurality of the printing apparatuses can be reduced appropriately.

The embodiment of the present invention may be, for example, preferably utilized in a printing system.

Obviously, numerous modifications and variations of the present invention are possible in light of the above teachings. It is therefore to be understood that within the scope of the appended claims, the invention may be practiced otherwise than as specifically described herein.

1. A printing system comprising:
a plurality of inkjet printing apparatuses to print a same image based on output image data having been adjusted depending on color reproduction characteristic with respect to each of the plurality of inkjet printing apparatuses; and
an image processing apparatus configured to generate output image data representing image to be printed by each of the plurality of inkjet printing apparatuses, the image processing apparatus comprising:
a printing data acquisition device configured to acquire printing data which represent the image with a color of a color system that does not depend on color reproduction characteristic of ink used in the plurality of inkjet printing apparatuses;
an output image generating device configured to convert the printing data to the output image data which represent the image with a color depending on the color reproduction characteristic of ink used in the plurality of inkjet printing apparatus, the output image generating device comprising:
a rasterizer configured to rasterize the image represented by the printing data according to resolution of the plurality of inkjet printing apparatus;
an apparatus common color convertor configured to execute common color conversion for the plurality of inkjet printing apparatuses using one ICC profile common to the plurality of inkjet printing apparatuses; and
an adjuster configured to reduce variation of the color reproduction characteristic with respect to each of the plurality of inkjet printing apparatuses using calibration information which is prepared for each of the plurality of inkjet printing apparatuses depending on the color reproduction characteristic with respect to each of the plurality of inkjet printing apparatuses to generate the output image data having been adjusted depending on the color reproduction characteristic with respect to each of the plurality of inkjet printing apparatuses; and
a data output processing device configured to output the output image data having been generated to the plurality of inkjet printing apparatuses.

2. The printing system according to claim 1, further comprising:
a color chart printing apparatus to print a color chart that is previously set using the plurality of inkjet printing apparatuses;
a color measurement result acquiring apparatus configured to measure the color chart printed by the color chart printing apparatus with a colorimeter to acquire a color measurement result with respect to a printing result of each of the plurality of inkjet printing apparatuses; and
a calibration information generating apparatus configured to generate the calibration information corresponding to each of the plurality of inkjet printing apparatuses based on the color measurement result corresponding to each of the plurality of inkjet printing apparatuses.

3. The printing system according to claim 1, wherein the output image generating device comprises an RIP (Raster Image Processor) configured to generate the output image data based on the printing data,
wherein the color used in the printing data comprises first device depending color dependent on color reproduction characteristic with respect to a predetermined device,
wherein the apparatus common color converter includes
a first common color converter configured to convert the first device depending color used in the printing data into first device independent color using a first ICC profile that is common to the plurality of inkjet printing apparatuses, and
a second common color converter configured to convert the first device independent color converted by the first common color converter into second device depending color dependent on the color reproduction characteristic of the ink using a second ICC profile that is common to the plurality of inkjet printing apparatuses,
wherein each of the inkjet printing apparatuses is provided with inkjet heads configured to eject at least inks of respective colors of CMYK inks,
wherein the adjuster reduces variation of the color reproduction characteristic with respect to each of the plurality of inkjet printing apparatuses after the second common color converter converts the first device independent color into second device depending color, and
wherein the calibration information comprises information to make colors of CMYK color system in the second ICC profile correspond to colors which have been corrected for the plurality of inkjet printing apparatuses respectively.

4. The printing system according to claim 1,
wherein the output image generating device comprises an RIP (Raster Image Processor) configured to generate the output image data based on the printing data,
wherein the color used in the printing data comprises third device depending color dependent on color reproduction characteristic with respect to a predetermined device,
wherein the apparatus common color converter includes
a first common color converter configured to convert the third device depending color used in the printing data into second device independent color using a first ICC profile that is common to the plurality of inkjet printing apparatuses, and
a second common color converter configured to convert the second device independent color converted by the first common color converter into fourth device depending color dependent on the color reproduction characteristic of the ink using a second ICC profile that is common to the plurality of inkjet printing apparatuses,
wherein the adjuster reduces variation of the color reproduction characteristic with respect to each of the plurality of inkjet printing apparatuses before the first common color converter converts the third device depending color into second device independent color,
wherein the calibration information comprises information to correct the third device depending color, the third device depending color corresponding to color which has been corrected for each of the plurality of inkjet printing apparatuses.

5. The printing system according to claim 1,
wherein the output image generating device comprises an RIP (Raster Image Processor) configured to generate the output image data based on the printing data,
wherein the color used in the printing data comprises fifth device depending color dependent on color reproduction characteristic with respect to a predetermined device,
wherein the apparatus common color converter includes
a first common color converter configured to convert the fifth device depending color used in the printing data into third device independent color using a first ICC profile that is common to the plurality of inkjet printing apparatuses, and
a second common color converter configured to convert the third device independent color converted by the first common color converter into sixth device depending color dependent on the color reproduction characteristic of the ink using a second ICC profile that is common to the plurality of inkjet printing apparatuses,
wherein the adjuster reduces variation of the color reproduction characteristic with respect to each of the plurality of inkjet printing apparatuses after the first common color converter converts the fifth device depending color into third device independent color and before the second common color converter converts the third device independent color into sixth device depending color, and
wherein the calibration information comprises information to correct the third device independent color, the third device independent color corresponding to color which has been corrected for each of the plurality of inkjet printing apparatuses.

6. A method for processing image data, comprising:
acquiring printing data which represent image with a color of a color system that does not depend on color reproduction characteristic of ink used in a plurality of inkjet printing apparatus to print of a same image based on output image data having been adjusted depending on color reproduction characteristic with respect to each of the plurality of inkjet printing apparatuses;
converting the printing data to the output image data which represent the image with a color depending on the color reproduction characteristic of ink and based on the plurality of inkjet printing apparatuses are to print, the converting step comprising:
rasterizing the image represented by the printing data according to resolution of each of the plurality of inkjet printing apparatuses;
executing common color conversion for the plurality of inkjet printing apparatuses using one ICC profile common to the plurality of inkjet printing apparatuses; and
reducing variation of the color reproduction characteristic with respect to each of the plurality of inkjet printing apparatuses using calibration information which is prepared for each of the plurality of inkjet printing apparatuses depending on the color reproduction characteristic with respect to each of the plurality of inkjet printing apparatuses to generate the output image data having been adjusted depending on the color reproduction characteristic with respect to each of the plurality of inkjet printing apparatuses; and
outputting the output image data having been generated to the plurality of inkjet printing apparatuses.

7. A non-transitory computer-readable recording medium having program code stored thereon which, when executed by a computer, causes the computer to perform an image processing method for performing a plurality of application programs, the image processing method comprising:
acquiring printing data which represent image with a color of a color system that does not depend on color reproduction characteristic of ink used in a plurality of inkjet printing apparatus to print of a same image based on output image data having been adjusted depending on color reproduction characteristic with respect to each of the plurality of inkjet printing apparatuses;
converting the printing data to the output image data which represent the image with a color depending on the color reproduction characteristic of ink and based on the plurality of inkjet printing apparatuses are to print, the converting step comprising:
rasterizing the image represented by the printing data according to resolution of each of the plurality of inkjet printing apparatuses;
executing common color conversion for the plurality of inkjet printing apparatuses using one ICC profile common to the plurality of inkjet printing apparatuses; and
reducing variation of the color reproduction characteristic with respect to each of the plurality of inkjet printing apparatuses using calibration information which is prepared for each of the plurality of inkjet printing apparatuses depending on the color reproduction characteristic with respect to each of the plurality of inkjet printing apparatuses to generate the output image data having been adjusted depending on the color reproduction characteristic with respect to each of the plurality of inkjet printing apparatuses; and
outputting the output image data having been generated to the plurality of inkjet printing apparatuses.
